(19) United States
(12) Patent Application Publication
(10) Pub. No.: US 2018/0363387 A1
(43) Pub. Date: Dec. 20, 2018

(54) NEAR-SQUARE MODIFIED BUTTRESS THREAD FORM ENABLING RUN-IN AND RUN-OUT THREADS

(71) Applicant: NextThread LLC, Odessa, TX (US)

(72) Inventor: Edward O. Banker, Houston, TX (US)

(21) Appl. No.: 15/622,967

(22) Filed: Jun. 14, 2017

(51) Int. Cl. E21B 17/042; F16L 15/06

(52) U.S. Cl. CPC E21B 17/042; F16L 15/06

(57) ABSTRACT

A near-square modified buttress thread form includes a pin that includes a plurality of pin threads, a box that includes a plurality of box threads, and an offset pitch line. Each pin and box thread includes a stab flank, a crest, a load flank, and a root, where the root and the crest are substantially parallel to a longitudinal axis of a pipe body, and a stab flank angle of the stab flank is larger than a load flank angle of the load flank. The offset pitch line is offset from a midpoint of each flank by a predetermined amount that provides flank-to-flank contact and root-crest clearance when the pin and the box are fully engaged. The load flank and the stab flank angles are made sufficiently small to form a near-square thread, which in turn allows partial threads (run-in and run-out threads) to mate.

### BACKGROUND OF THE INVENTION

Conventional casing and tubing, commonly referred to as oilfield country tubular goods (“OCTG”), are used to construct and produce oil and gas wells. Conventional casing and tubing are typically threaded in accordance with American Petroleum Institute (“API”) standards or equivalents thereof to provide connectivity via various types of connections. Conventional oilfield couplings are similar to plumbing couplings in that pipe segments are externally threaded on distal ends and couplings are internally threaded on distal ends such that two pipe segments may be joined together by a single coupling. Pipe is typically specified by its outer diameter (“OD”), but its inner diameter (“ID”) varies based on the wall thickness. For example, the API typically specifies OD plus or minus variance and wall thickness plus or minus variance. The ID is typically a function of the nominal OD and wall thickness, plus or minus the combined variances. Conventional oilfield couplings typically use pipe dope on the threads in an attempt to seal pressure.

For demanding applications, such as high pressure wells, a number of proprietary connections, commonly referred to as premium connections, have been designed to provide improved pressure seal. These premium connections differ from API connections in features such as, for example, proprietary thread shapes, metal seals, and torque shoulders. The majority of premium connections, like API connections, are threaded and coupled. These premium oilfield couplings are typically used in situations where pressure needs to be balanced and maintained during various drilling or production operations. When there is a need to limit the OD of a string to the OD of the pipe body, such as, for example, a borehole with limited diametrical clearance, the connection between two pipe segments may be machined directly into the wall of the respective joints of the pipe. This type of connection is commonly referred to a flush joint connection.

### BRIEF SUMMARY OF THE INVENTION

According to one aspect of one or more embodiments of the present invention, a near-square modified buttress thread form includes a pin that includes a plurality of pin threads, a box that includes a plurality of box threads, and an offset pitch line. Each pin and box thread includes a stab flank, a crest, a load flank, and a root, where the root and the crest are substantially parallel to a longitudinal axis of a pipe body, and a stab flank angle of the stab flank is larger than a load flank angle of the load flank. The offset pitch line is offset from a midpoint of each flank by a predetermined amount that provides flank-to-flank contact and root-crest clearance when the pin and the box are fully engaged. The load flank and the stab flank angles are made sufficiently small to form a near-square thread, which in turn allows partial threads (run-in and run-out threads) to mate. The run-in and run-out thread pairs increase the critical section area of both the pin and the box, increasing the tensile efficiency of the connection.

Other aspects of the present invention will be apparent from the following description and claims.

### BRIEF DESCRIPTION OF THE DRAWINGS

FIG. 1 shows a cross-sectional view of a portion of a conventional ACME or trapezoidal thread form.

FIG. 2 shows a cross-sectional view of a portion of a conventional breech-lock buttress thread form.

FIG. 3 shows a cross-sectional view of a portion of a conventional API buttress thread form.

FIG. 4 shows a cross-sectional view of a portion of a conventional threaded and coupled connection.

FIG. 5 shows a cross-sectional view of a portion of a conventional flush connection.

FIG. 6 shows a cross-sectional view of a portion of a conventional semi-flush connection.

FIG. 7 shows a cross-sectional view of a portion of a conventional machining of a run-out thread.

FIG. 8 shows a cross-sectional view of a portion of a conventional machining of a run-in thread.

FIG. 9 shows a conventional measurement of an included angle of a thread form.

FIG. 10 shows a conventional run-out thread on a pin mating with a full thread on a box.

FIGS. 11A and 11B show a detailed perspective view showing the advantage of a conventional run-out thread mating with a full thread in a threaded and coupled type connection.

FIG. 12 shows a conventional thread form with an included angle substantially greater than zero that does not mate well.

FIG. 13 shows a conventional square thread form with an included angle of zero that does not mate well.

FIG. 14 shows a near-square modified buttress thread form enabling run-in and run-out threads in accordance with one or more embodiments of the present invention.

FIGS. 15A, 15B, and 15C show a near-square modified buttress thread form, machined as full threads, mating to achieve flank-to-flank contact with root-crest clearance in accordance with one or more embodiments of the present invention.

FIGS. 16A, 16B, and 16C show a near-square modified buttress thread form, machined as partial threads, mating to achieve flank-to-flank contact with root-crest clearance, and show that the near-square aspect of the thread form enables fitting of run-in, run-out threads and increase the critical section area of the connection in accordance with one or more embodiments of the present invention.

### DETAILED DESCRIPTION OF THE INVENTION

One or more embodiments of the present invention are described in detail with reference to the accompanying figures. For consistency, like elements in the various figures are denoted by like reference numerals. In the following detailed description of the present invention, specific details are set forth in order to provide a thorough understanding of the present invention. In other instances, well-known features to one of ordinary skill in the art are not described to avoid obscuring the description of the present invention.

Threaded connections find their genesis in antiquity. However, the need for standardization did not arise until the industrialization of the mid-nineteenth century where the mass production of machinery required standardization of components and fasteners used for assembly. As the focus turned to thread forms, threads were usually square or V-shaped. As technology and manufacturing techniques improved other thread forms evolved, notably the trapezoidal thread form, the buttress thread form, and the breech-lock buttress thread form. Their development was driven by the need to have thread forms that were easier to manufacture than square thread forms and would perform better than V-shaped thread forms in specific applications. For the disclosure that follows, the term thread shall be used to describe a single root and crest of a thread form that may be used as part of a pin or box. The term thread tooth shall be used to describe the protrusion establishing the crest of the thread. The term thread groove shall be used to describe the valley formed by adjacent thread teeth establishing the root of the thread. The term thread form shall be used to describe the features of a threads pin and box that define engagement, and may describe the entire threaded engagement or portions thereof.

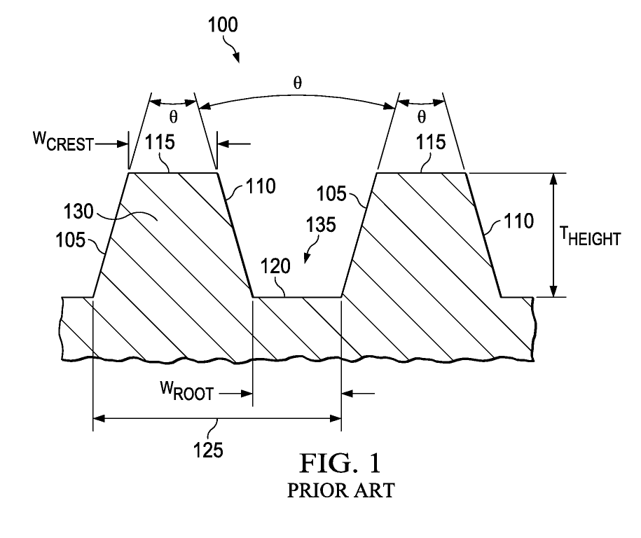

FIG. 1 shows a cross-sectional view of a portion of a conventional ACME or trapezoidal thread form 100. While FIG. 1 shows only a portion of the thread form, one of ordinary skill in the art will recognize that the depicted portion of the thread form may constitute a portion of the pin (male) or a portion of the corresponding box (female) that engage as a mated thread pair. The ACME or trapezoidal thread form 100 was developed in the late 1800s as a thread form suitable for use in power transmission applications. The ACME or trapezoidal thread form 100 provided a number of advantages over the then-traditionally used square thread form (not shown), because it was easier to manufacture, was stronger, wore better, and provided improved engagement over square thread forms. The ACME or trapezoidal thread form 100 includes a stab flank 105, a crest 115, a load flank 110, and a root 120 that form a thread 125 with tooth 130 and a groove 135 having a substantially trapezoidal shape.

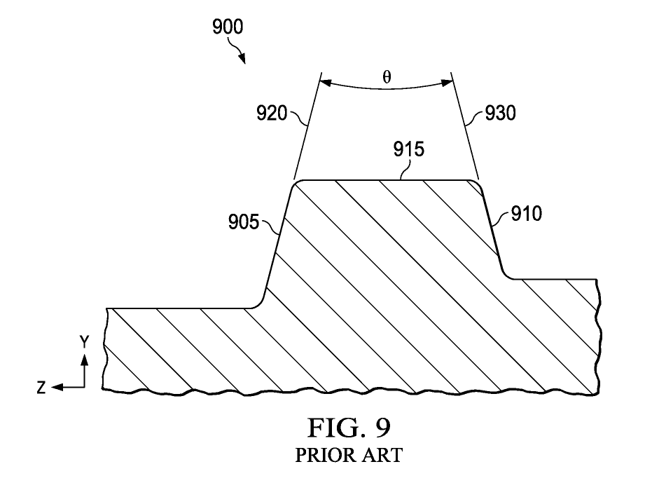

The stab flank 105 and the load flank 110 each have a flank angle (not independently illustrated) of 14.5° from a perpendicular line to the root 120. The ACME or trapezoidal thread form 100 has a thread height, T_{Height} equal to one half of the thread pitch, T_{Pitch}, where the thread pitch, Tp_{Pitch}, is the distance from the crest 115 of one thread 125 to the crest 115 of the next thread 125 (or similarly the distance from the root 120 of one thread 125 to the root 120 of the next thread 125). The crest 115 and the root 120 are substantially flat. The crest 115 has a crest width, W_{Crest}, of 0.3707*T_{Pitch}. Similarly, the root 120 has a root width, W_{Root,} equal to W_{Crest}. Historically, the ACME thread form differed from the later-standardized trapezoidal thread form in that the ACME thread form had an included angle, θ, of 29° , whereas the trapezoidal thread form had an included angle, θ, of 30° . The included angle, θ, is the angle between adjacent threads 125, described with more with respect to FIG. 9 herein.

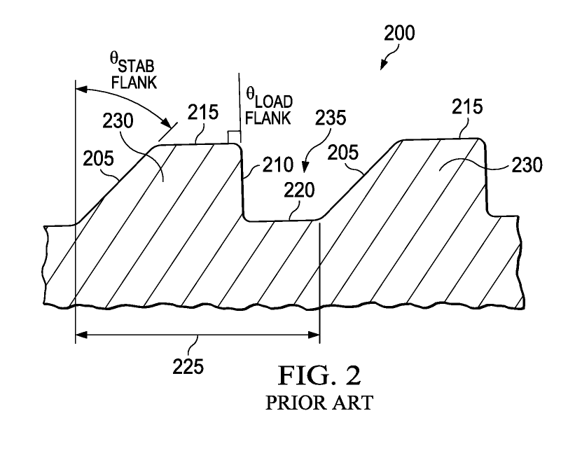

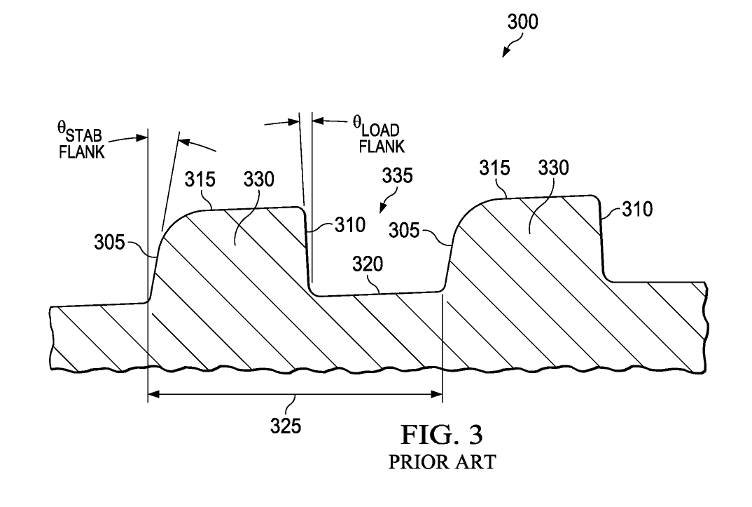

FIG. 2 shows a cross-sectional view of a portion of a conventional breech-lock buttress thread form 200. The conventional breech-lock buttress thread form 200 was designed for transmitting high unidirectional axial loads in machinery. The conventional breech-lock buttress thread form 200 includes a stab flank 205, a crest 215, a load flank 210, and a root 220 that form a thread 225 with tooth 230 and groove 235 having a substantially trapezoidal shape. The stab flank 205 has a stab flank angle, θ_{Stab Flank}, of 45° in the assembly direction and the load flank 210 has a load flank angle, θ_{Load Flank}, of 90° in the load bearing direction. While the conventional breech-lock buttress thread form 200 represented an improvement over the ACME or traditional thread form (100 of FIG. 1), for various reasons discussed in more detail herein with respect to FIG. 3, it was not widely adopted in OCTG.

FIG. 3 shows a cross-sectional view of a portion of a conventional API buttress thread form 300. The API adopted and standardized a variant of the conventional breech-lock buttress thread form (200 of FIG. 2) for use in oil and gas applications that sought to improve the fluid and pressure sealing function of the thread form. The conventional API buttress thread form 300 is often used in casing products to not only provide tensile strength nearly equal to that of the pipe body, but also to provide fluid and pressure sealing capabilities. The conventional API buttress thread form 300 includes a stab flank 305, a crest 315, a load flank 310, and a root 320 that form a thread 325 with tooth 330 and groove 335 having a substantially trapezoidal shape. However, in contrast to the conventional breech-lock buttress thread form (200 of FIG. 2), the stab flank 305 has a stab flank angle, θ_{Stab Flank}, of 10° in the assembly direction and the load flank 310 has a load flank angle, θ_{Load Flank}, of 3° in the load bearing direction. The conventional API buttress thread form 300 found application and is widely used in OCTG, namely in threaded and coupled connections used for casing.

OCTG connections are primarily intended for pressure control in well bores. API standard connections, in almost all cases, use thread seals. That is, the interference fit of the threads, enhanced by thread lubricant or pipe dope, serves to seal pressure. Practically, all API connections are threaded and coupled type connections. That is, both distal ends of a length of pipe are threaded with external threads such that each end is considered a pin end. These lengths of pipe, often 30 or 40 feet in length, are then joined by short, internally threaded couplings, to form a complete, down-hole pressure vessel that may range from a few thousand feet to greater than 20,000 feet in length. As the oil and gas extraction industry matured, wells were drilled deeper and deeper. Deeper wells meant greater formation pressures, which in turn required better sealing mechanisms. Proprietary, or premium, connections were designed with metal-to-metal seals such that the connection's pressure resistance matched that of the pipe body. These connections typically have positive torque shoulders that stop rotational assembly and locate the metal seals properly in the assembly in an effort to improve the sealing mechanism.

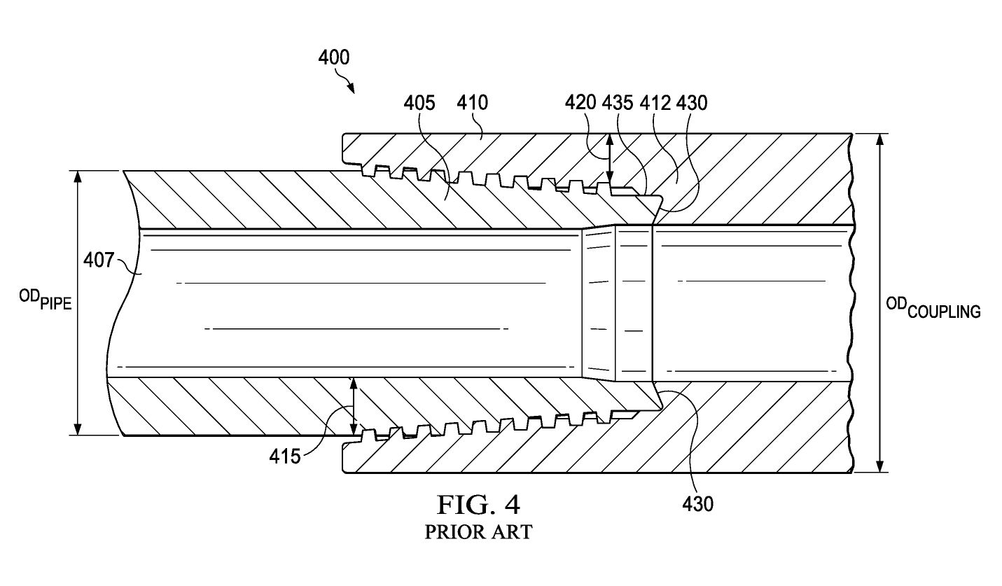

FIG. 4 shows a cross-sectional view of a portion of a conventional threaded and coupled connection 400. Conventional threaded and coupled connection 400 includes a pin portion 405 of a pipe 407 (partially shown) and a box portion 410 of a coupling 412 (partially shown). One of ordinary skill in the art will recognize that pipe 407 includes another pin portion (not shown) and coupling 412 includes another box portion (not shown) configured to receive another pin portion (not shown) of another pipe (not shown) thereby serving as a connection for two pipe segments 407. The threaded and coupled connection 400 includes a metal-to-metal seal 435 formed by an interference fit between the pin 405 and the box 410 in the small near-cylindrical area near the torque shoulder 430. The threaded and coupled connection 400 also has a positive torque shoulder 430. Positive torque shoulder 430 is a shoulder that stops axial assembly just prior to full stab flank contact and includes a negative flank angle. Positive torque shoulders are common in premium connections with metal seals and negative flank angles are also common as they lock the seal under high tensile loading conditions.

Generally speaking, the critical cross section area is the area of the cross-section where a sample under axial load, be it a coupling or connection, tubular or pipe, or other material, fails during a tensile pull to failure. The American Society for Testing and Materials (“ASTM”) specifies standards that include criteria to be used to determine the yield and tensile strength of specific types of steel. The yield strength multiplied by the critical cross section area determines at what force the sample will begin to yield or permanently deform. The tensile strength multiplied by the critical cross section area determines what force will cause the sample to fail or part. For a connection, the critical cross section area is the area under the last fully engaged thread. Returning to the figure, the critical cross section area 415 of the pin 405 (of pipe 407) is determined by the wall thickness under the last engaged thread furthest from the coupling 412 as shown. Similarly, the critical cross section area 420 of the box 410 (of coupling 412) is determined by the wall thickness under the last engaged thread nearest the distal end of the pin 405 as shown.

It is important to note that the critical cross section area 415 of the pin 405 (of pipe 407) is limited by the OD and the ID of the pipe 407 body itself. However, coupling 412 may be designed with a larger OD and wall thickness than that of the pipe 407 body, thereby making it stronger in tensile loading situations than the pipe 407 body. The critical cross section areas 415 of the pin 405 and the coupling 420 are prone to failure under high tensile loading, and as such, are commonly used for rating connections specified for use in OCTG. It is important to note that, because of the design of threaded and coupled connections, the OD of the coupling 412 is larger than the OD of the pipe 407. As such, the size of the wellbore dictates the OD size of coupling 412 that may be used, which in turn dictates the smaller OD size, and more importantly smaller ID size, of pipe 407 that may be used.

Deeper wells gave rise to casing and completion programs that required connections where the OD at the point of connection is flush or nearly flush with the OD of the pipe body. These flush and near-flush connections still had similar design requirements with respect to both tensile strength and pressure integrity, namely that the critical cross-sectional area of the connection be as close to the critical cross section of the pipe body as possible. The tensile efficiency of a connection is the ratio of the critical cross-sectional area of the connection to the critical cross section area of the pipe body. Thus, to optimize the tensile efficiency of any threaded connection, the critical cross-sectional area of the connection should be as close as possible to the critical cross section area of the pipe or tubulars being connected.

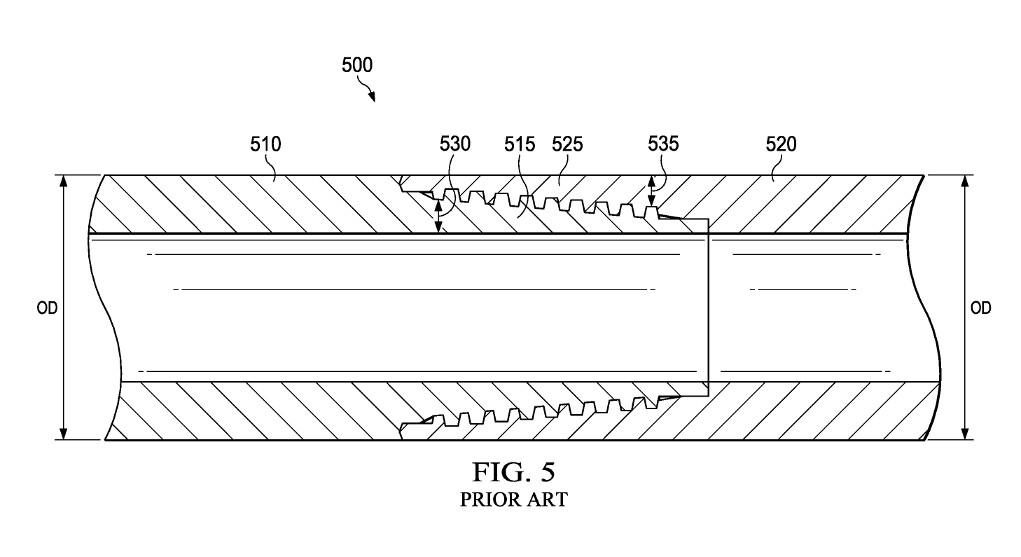

FIG. 5 shows a cross-sectional view of a portion of a conventional flush connection 500. Conventional flush connection 500 includes a first pipe 510 and a second pipe 520, where in the depicted portion first pipe 510 includes an externally threaded pin portion 515 and the second pipe 520 includes an internally threaded box portion 525. In contrast to threaded and coupled connections that require the use of a coupling to join two pipe segments together, conventional flush connections 500 are configured such that pipe segments 510 can connect to other pipe segments 520 without the use of a coupling. Typically, pipe 510, 520 have a pre-determined shape and OD and is cold-formed such that the ID of the pin end is reduced and bored to a known dimension. It is important to note that, because of the way OCTG's dimensions and tolerances are defined, the ID may vary by a relatively large amount. External threads are machined outside one distal pin end and internal threads are machined inside one distal box end. Thus each pipe 510, 520 includes both an externally threaded pin end (e.g., 515) and an internally threaded box end (e.g., 525) allowing for their interconnection. Because the OD of first pipe 510 is the same as the OD of the second pipe 520, this type of connection is commonly referred to as a flush connection. One of ordinary skill in the art will recognize that first pipe 510 and second pipe 520 are the same type of pipe, they are simply provided unique reference numbers for clarity. As such, a plurality of pipe 510 or 520 may be joined together with pin end 515 connecting to box end 525 until the desired length of pipe is achieved. As the need to go deeper and deeper has required better tensile efficiency, pressure sealing ability, and flush or near flush ODs, these types of connections have proven problematic because of weaknesses in the critical cross section areas.

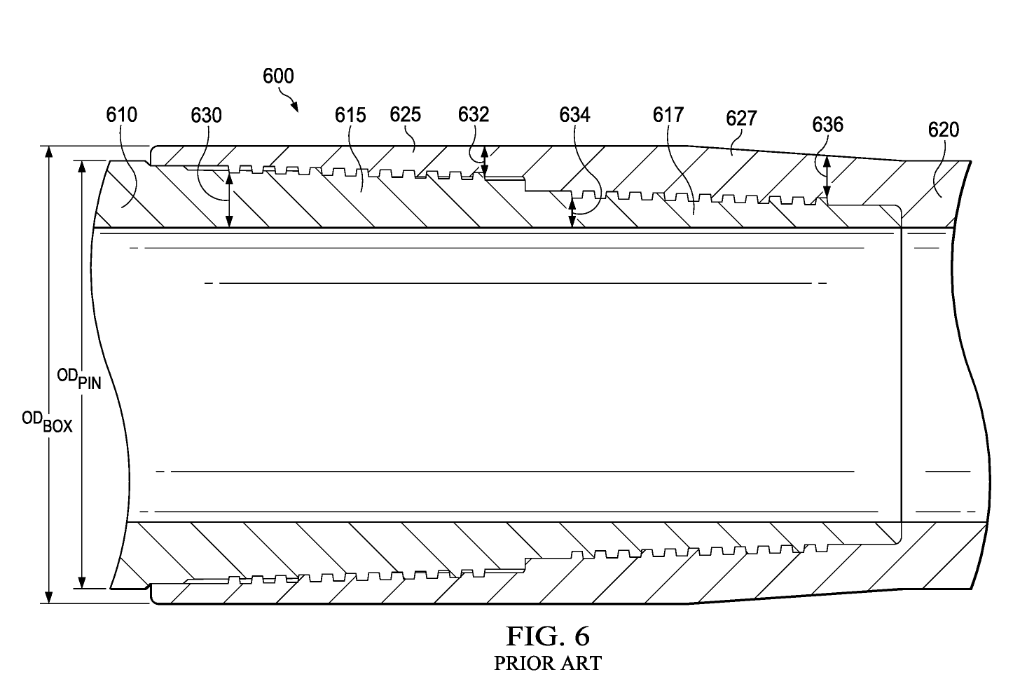

FIG. 6 shows a cross-sectional view of a portion of a conventional semi-flush connection 600. Conventional semi-flush connection 600 includes a first pipe 610 and a second pipe 620, where in the depicted portion first pipe 610 includes 2-step externally threaded pin portions 615, 617 and the second pipe 220 includes 2-step internally threaded box portions 625, 627. In contrast to threaded and coupled connections that require the use of a coupling to join two pipe segments together, conventional semi-flush connections 600 are configured such that pipe segments 610 can connect to other pipe segments 620 without the use of a coupling. Typically, pipe 610, 620 have a pre-determined shape and external threads are machined outside one distal pin end and internal threads are machined inside one distal box end. Thus each pipe 610, 620 includes both an externally threaded pin end (e.g., 615, 617) and an internally threaded box end (e.g., 625, 627) allowing for their interconnection. However, the OD of the pin ends (e.g., 615, 617) of each pipe 610, 620 are tapered down from the OD of the box ends (e.g., 625, 627). In the case of a 2-step connection, such as that depicted in the conventional semi-flush connection 600 of FIG. 6, the critical cross section area is the lessor of the area under the last fully engaged pin thread 630, the last fully engaged box thread 636, or the sum of the combined areas of the last fully engaged pin 634 and box 632 threads about the center shoulder. One of ordinary skill in the art will recognize that first pipe 610 and second pipe 620 are the same type of pipe, they are simply provided unique reference numbers for clarity. As such, a plurality of pipe 610 or 620 may be joined together with pin ends 615, 617 connecting to box ends 625, 627 until the desired length of pipe is achieved.

In FIGS. 1 through 3, various classical thread forms are shown. These thread forms are considered classic because they have a positive included angle and a constant thread pitch. A positive included angle means the angle of the stab flank, sometimes referred to as the stab flank angle, is positive with respect to the perpendicular to the longitudinal axis of the tube or pipe body and the angle of the load flank, sometimes referred to as the load flank angle, may be positive or negative. However, the sum of the stab flank angle and the load flank angle is greater than zero, as shown in FIG. 9. Other thread forms have been used in the field, notably wedge threads, which have a negative included angle. However, threads that do not have a positive included angle are more difficult to thread, requiring two or three times as many threading passes to manufacture. More importantly, thread forms with negative included angles are more difficult to inspect, which is important for quality control reasons. This is because a thread with a negative included angle must also have a variable thread pitch to facilitate assembly. The pitch is the axial distance from corresponding points on adjacent threads in the same axial plane and on the same side of the longitudinal axis. On constant pitch threads, it is a constant and is the reciprocal of the thread lead. For example, a five (5) pitch thread has five (5) threads per inch and a lead of 0.200″. For a wedge thread, the pitch varies from thread to thread.

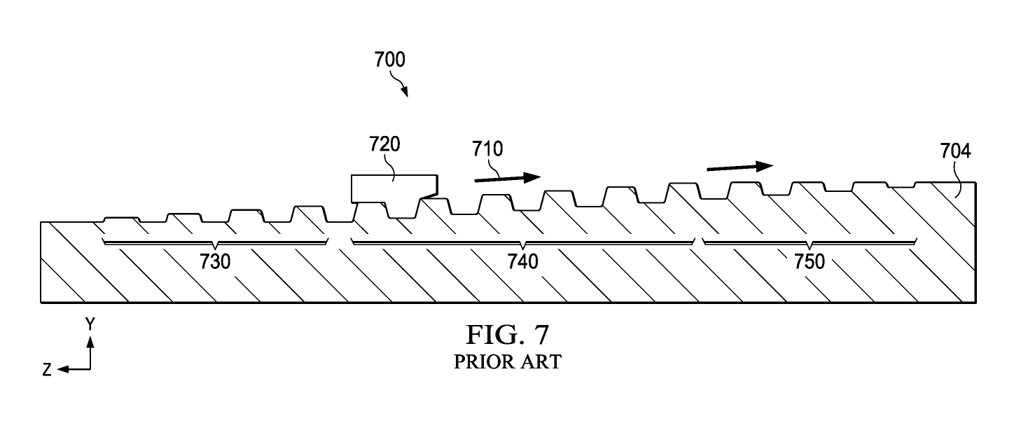

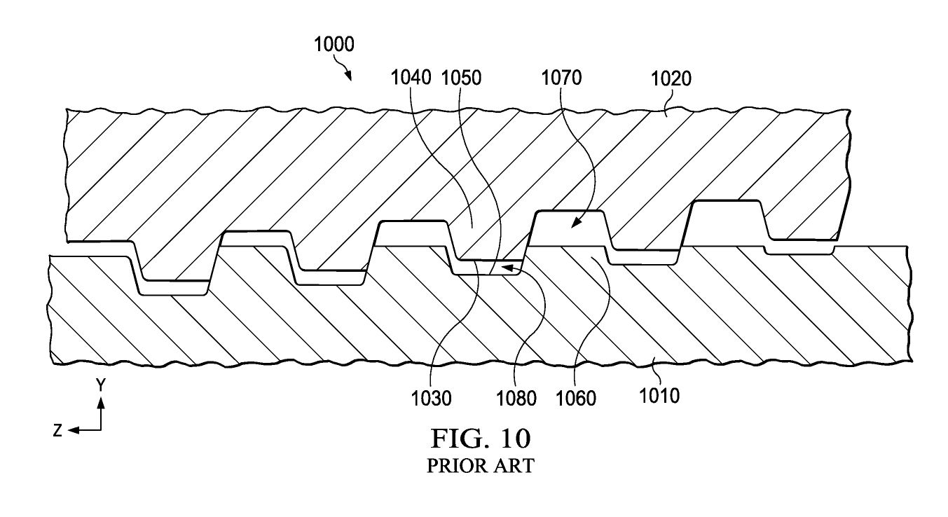

FIG. 7 shows a cross-sectional view of a portion of a conventional machining of run-in threads 730, full threads 740, and run-out threads 750. Full tapered threads 740 are full threads cut on a tapered path 710 with an insert 720 that fully machines the entire thread form (not shown) on that portion of the pipe 704 body. Sufficient metal exists in the wall of the pipe 704 that the insert 720 can machine the complete thread form. Run-out threads 750 are partially machined threads cut on the tapered path 710 with insert 720 that partially machines the roots and the crests of the thread form of the pipe 704. This creates a thread form that starts out as a fully machined thread (full thread height, full thread groove) and progressively becomes truncated (truncated thread height, truncated thread groove). As the root becomes narrower, the thread tooth becomes wider because it is formed by the crest of the thread insert (e.g., 720). FIG. 10 shows partial run-out threads, machined on a pin, mating with full threads machined on a box or coupling. This combination mates very well.

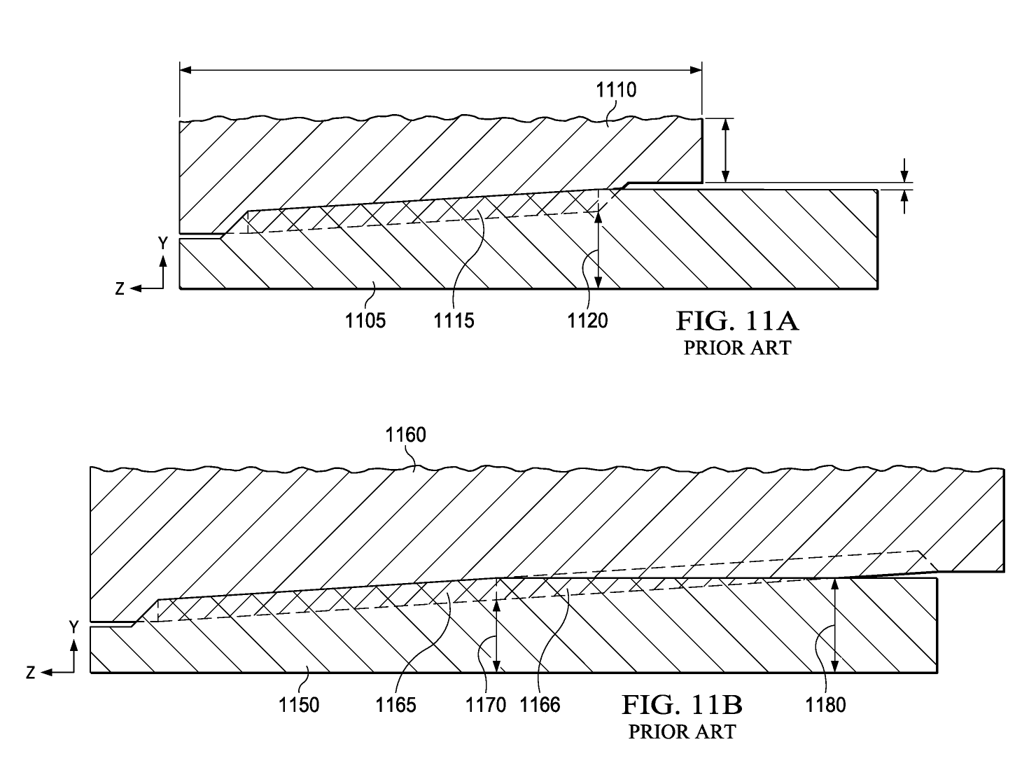

As deeper and deeper wells were drilled, the need for higher tensile efficiency was recognized. The run-out thread form was a breakthrough in the improvement of the tensile efficiency for tubular connections. As illustrated in FIGS. 11A and 11B, the run-out thread form moves the pin critical section area from a value equal to approximately the OD of the pipe body minus two (2) times the thread height to a value equal to approximately the OD of the pipe body itself, thus the connection tensile efficiency increases from some 80% of the pipe body to nearly or equal to 100%. The last scratch, the diameter of the last cut of the threading insert, becomes the last engaged thread. This means that the width of the thread tooth at the crest is less than the width of the thread tooth at the root. Conversely, the width of the thread groove at the opening is greater than the width of the thread groove at the root or base. The run-out thread works because the last scratch is the root of the pin thread. It mates with the crest of the full height box thread, machined on a coupling. FIG. 10 shows the fit of full threads into partial, run-out threads. FIGS. 11A and 11B show the increase in critical section area gained by using run-out threads mated with full threads in a threaded and coupled connection.

Other designs in the mid-twentieth century attempted to use a run-in thread. A run-in thread is constructed by machining a cone on the body of the tubular body, and then machining the thread on a cylindrical path into the cone until the thread reaches its full height. At that point, the threading path changes to the taper of the cone. The run-in thread was an attempt to provide a mate to the run-out thread, to increase the tensile efficiency for a smaller OD connection.

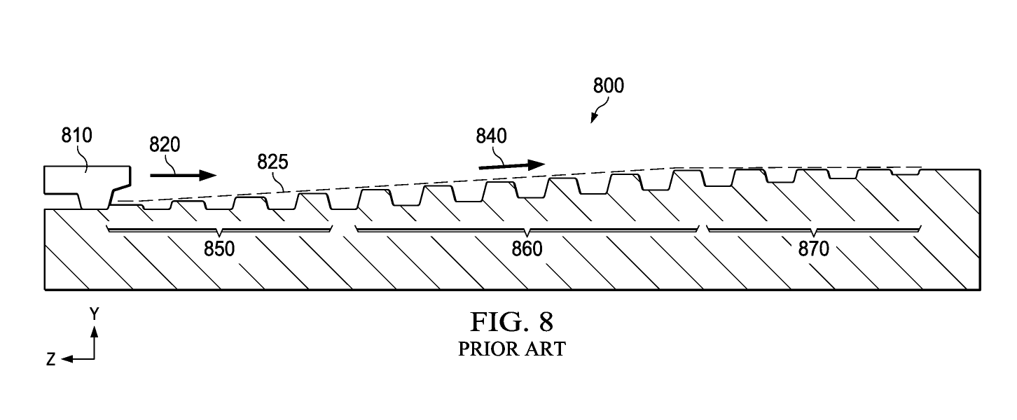

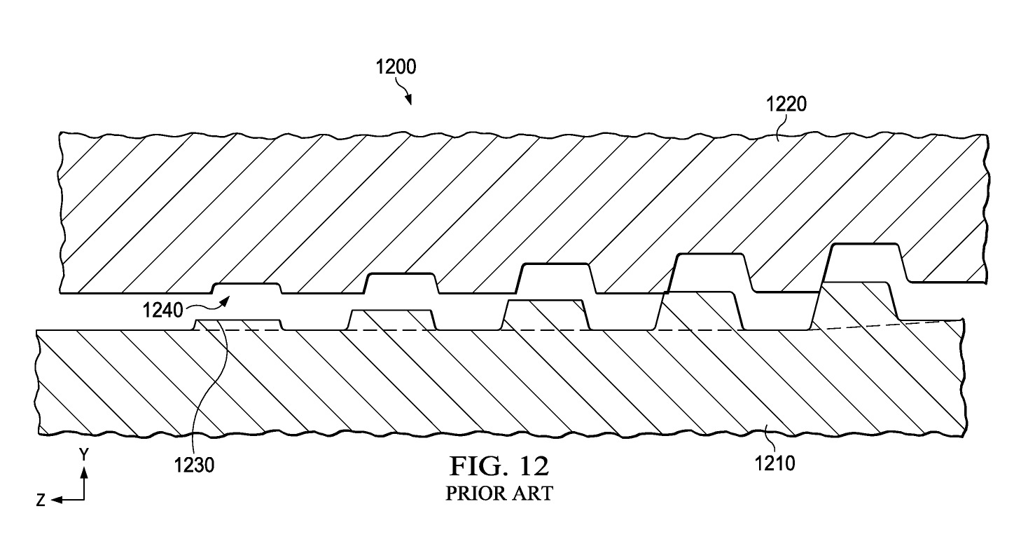

FIG. 8 shows a cross-sectional view of a portion of a conventional machining of a run-in thread 800. Run-in threads 800 are partially machined threads constructed by machining with an insert 810 along a straight path 820, parallel with the central axis of the tubular member 830, forming run-in threads 850, into a conical form, with a taper equal to the thread taper that starts at the root diameter of the thread, and continues to form the full thread height. At the length at which the conical form equals the height of the full threads, the run-in threads are complete and the threading tool 810 changes path from straight to one of the thread taper 840 and begins to machine the full threads 860. Run-out threads 870 are partially machined threads cut on the tapered path 840. The difficulty with run-in threads is that the thread tooth is wider at its base than its crest. When truncated, the partial tooth, because of the positive included angle, becomes wider and the truncated groove opening becomes narrower. Therefore, at assembly, one faces the conundrum of inserting a wide (partial) thread tooth into a narrow (partial) thread groove. The partial threads do not mate well, as illustrated in FIG. 12.

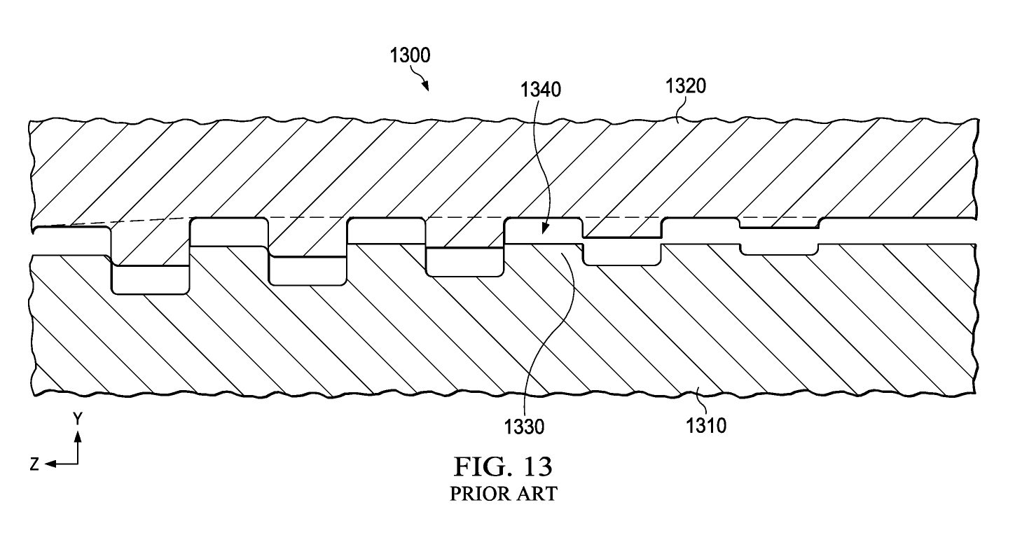

Several different methods have been proposed to overcome this problem. Early attempts were made to shave the run-in threads to narrow the thread teeth, however, it presented a difficult machining operation. Other attempts sought to thread a square, or near-square, thread form. A square thread form is one where the width of the thread tooth and the width of the thread groove are equal or very nearly so. Therefore, with a square thread form, a partially truncated thread tooth, or ridge, will fit into a partially truncated thread groove. However, square thread forms have difficulty engaging as discussed in more detail herein with reference to FIG. 13.

FIG. 9 shows a conventional measurement of an included angle, θ, of a partial thread form 900. As discussed above with respect to FIG. 1, the included angle, θ, is the angle between adjacent threads (e.g., 125 of FIG. 1). However, the included angle, θ, may also be defined as the angle formed by the intersection of a line 920 drawn from the stab flank 905 angle and the line 930 drawn from the load flank 910 angle, which may also be the angle formed by the width of the crest 915. The concept of the included angle is important because, as discussed above, an issue with the mating of run-out and run-in threads is that the positive included angle, formed by a positive stab flank angle and a positive or negative load flank angle, where their sum is greater than zero, gives rise to mating, or engagement, issues.

FIG. 10 shows a conventional run-out thread on a pin 1010 mating with a full thread on a box 1020. While conventional run-out threads have difficulty mating with conventional run-in threads, a conventional run-out thread, here shown on a pin 1010, may engage well with a fully threaded box 1020. This combination of run-out threads mating, or engaging, with full threads works well because the crests 1030 of the full thread teeth 1040 match the roots 1050 of the run-out threads grooves 1080. Similarly, the partial teeth 1060 of the run-out threads fit well into the wide grooves 1070 of the full threads.

FIGS. 11A and 11B show a detailed perspective view showing the advantage of a conventional run-out thread mating with a full thread in, for example, a threaded and coupled type connection. In FIG. 11A, an API short thread couple type of connection with a threaded pin 1105 and a threaded box 1110 is shown. Because of the full thread engagement along the thread parallelogram 1165, the critical cross section 1120 of the pin 1105 is less, and often, significantly less, than the OD of the pipe body (not independently illustrated). In FIG. 11B, the advantage of using a conventional run-out thread (here on pin 1150) with a full thread (here on a box 1160) is more clearly shown. Because of the full thread engagement up to a point 1166 where it becomes partial run-out threads on the pin, the critical cross section area 1170 of the pin 1150 increases to critical cross section area 1180. As such, the critical cross section area of the pin 1150 increases by at least two (2) times the thread height. Thus, the tensile efficiency of the pin increases from some 80% of the pipe body to nearly or actually 100% of the pipe body.

While most premium and semi-premium connections use this concept, it cannot be used in flush or semi-flush connections because there is no room inside the wall of a tubular member to have full threads mating with run-out threads. As such, the only way to increase the critical cross section of a flush or semi-flush connection is to mate run-in threads with run-out threads, however, doing so has historically been problematic.

FIG. 12 shows a conventional thread form of run-in 1210 and run-out 1220 threads with an included angle (not independently illustrated) substantially greater than zero that does not mate well. When the included angle (not independently illustrated) is substantially greater than zero, the partial teeth (e.g., 1230) of the run-in threads of the pin 1210 become too wide and do not mate well in the decreasing width of the run-out thread grooves (e.g., 1240) of the box 1220. As such, the engagement of run-in and run-out threads with an included angle substantially greater than zero is problematic.

FIG. 13 shows a conventional square thread form of run-in 1310 and run-out 1320 threads with an included angle of zero that does not mate well. When the included angle is zero, the partial teeth (e.g., 1330) of the square thread of the pin 1310 mate with the partial thread groove (e.g., 1340) of the box 1320. While the use of square thread forms addresses the issue of engagement, they give rise to serious assembly issues. In OCTG, a problem with square thread forms, such as that illustrated in FIG. 13, is that there is no stabbing clearance. When assembling casing to be used in an oil or gas well, the first part of the casing assembly is picked up by the derrick and placed vertically into the well bore with the threaded box connection facing upward. The entire assembly is held by tools that transfer the weight of the assembly to the rig itself. Subsequent lengths of casing are picked-up into vertical position in the derrick and stabbed (i.e., the pin of the casing being added to the string is inserted into the box of the casing held by the rig). This stabbing procedure can be difficult as the length of casing may weigh several thousand pounds and may be influenced by wind and other environmental considerations. Once stabbed, the connection (pin and box) being made is assembled to the proper torque, while the entire string is held up by the derrick and lowered into the well bore. This process is repeated until the required length of casing is assembled. Therefore, an important aspect of OCTG connections is the ease of stabbing or assembly. Unfortunately, square threads provide no stabbing clearance.

While various thread forms have been developed, modified, and refined throughout the years, there remains a longstanding and unresolved need in the industry to provide a thread form for flush or semi-flush connections that provides high tensile efficiency, high compression efficiency, are capable of being more easily machined, and are more easily assembled.

In one or more embodiments of the present invention, a near-square modified buttress thread form provides near-square threads that enable partial run-in threads to mate with partial run-out threads that have as much stab flank-to-stab flank contact as possible to maximize resistance to compressive loading and to minimize circumferential stress in the fully assembled state. Put another way, near square run-in and run-out threads that mate or engage well, leading to substantially greater tensile capacity than similar connections without partial thread engagement. In addition, it is desirable to have load flank contact near 100% as the threads react with the torque shoulders within the connection.

To establish flank-to-flank contact with root-crest clearance, an offset pitch line for a tapered thread may be used. The pitch cone is an imaginary cone of such apex angle and location of its vertex and axis that its surface would pass through a tapered thread in such a manner as to make the widths of the thread ridge (or tooth) and the thread groove equal. The pitch line is the line on the cone that, when rotated about the central axis of the cone, is the generator of the pitch cone.

In one or more embodiments of the present invention, another means for establishing definable clearance between the roots and the crests of mating internal and external threads is to mate threads with an offset pitch line. An offset pitch line is a pitch line that is offset from the midpoint of the stab and load flank of the thread. The offsets, each above the mid-point of the load and stab flanks of the respective thread, fit with their mating thread along a common conical section of both threads, such that both the load and the stab flanks of both threads mate. Therefore, the threads are in contact along both the load and the stab flanks as the threads mate and the respective offset pitch lines align. Advantageously, flank to flank contact provides improved compressive resistance such that, when the load shifts from tensile axial loading to compressive axial loading, the thread flanks supporting the compressive load are already in contact. Further, flank to flank contact minimizes radial stress in the circumferential direction. Hoop stress, as radial stress in the circumferential direction, is commonly known and can, if great enough, result in split couplings or boxes. In addition, hoop stress contributes to stress erosion in the presence of H₂S, a common byproduct of many oil and gas wells.

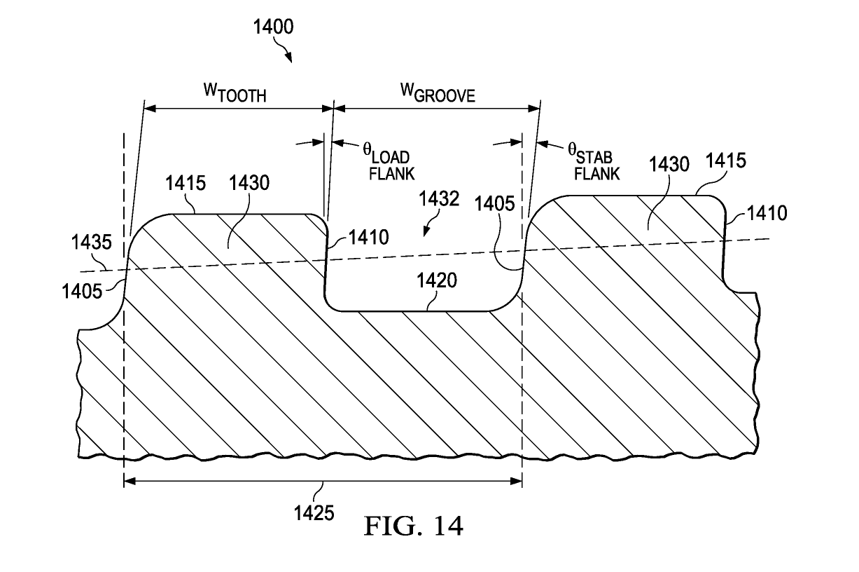

FIG. 14 shows a near-square modified buttress thread form 1400 enabling run-in and run-out threads in accordance with one or more embodiments of the present invention. Advantageously, near-square modified buttress thread form 1400 enhances the ability of the thread to be quickly and easily assembled, improves tensile efficiency, and improves pressure sealing ability suitable for use in flush or semi-flush connections. While FIG. 14 shows only a portion of the thread form, one of ordinary skill in the art will recognize that the depicted portion of the thread form may constitute a portion of the pin (male) or a portion of the corresponding box (female) that engage as a mated pair.

Near-square modified buttress thread form 1400 includes a stab flank 1405, a crest 1415, a load flank 1410, and a root 1420 that form a thread 1425 with tooth 1430 and groove 1432 having a somewhat trapezoidal shape. In certain embodiments, one or more of the edges between the stab flank 1405 and the crest 1415, the crest 1415 and the load flank 1410, the load flank 1410 and the root 1420, and the root 1420 and the stab flank 1405 may be radiused about one or more edges. The crest 1415 and the root 1420 are substantially parallel to a longitudinal axis of a pipe body (not independently illustrated).

In certain embodiments, the stab flank 1405 may have a stab flank angle, θ_{Stab Flank}, in a range between 1° and 9° in the assembly direction and the load flank 1410 may have a load flank angle, θ_{Load Flank}, in a range between 0° and 7° in the load bearing direction. In other embodiments, the stab flank 1405 may have a stab flank angle, θ_{Stab Flank}, in a range between 1° and 7° in the assembly direction and the load flank 1410 may have a load flank angle, θ_{Load Flank}, in a range between 0° and 4° in the load bearing direction. In still other embodiments, the stab flank 1405 may have a stab flank angle, θ_{Stab Flank}, in a range between 3° and 9° in the assembly direction and the load flank 1410 may have a load flank angle, θ_{Load Flank}, in a range between 1° and 7° in the load bearing direction. However, in all embodiments, the stab flank angle, θ_{Stab Flank}, of the stab flank 1405 shall be larger than the load flank angle, θ_{Load Flank}, of the load flank 1410.

An offset pitch line 1435, which is the generator of the cone that intersects the thread tooth 1430 and the thread groove 1432 such that the width of the tooth 1430, W_{Tooth}, is equal to the width of the groove 1432, W_{Groove}, that intersects the thread tooth 1430 on the load flank 1410 at a distance that is one-half of the load flank height minus a predetermined constant, δ, as measured from the thread crest 1415 (or conversely, one-half the load flank height plus the predetermined constant, δ, as measured from the thread root 1420). The offset pitch line 1435 intersects the stab flank 1405 at a distance of one-half of the stab flank height minus the predetermined constant, δ, as measured from the thread crest 1415 (or conversely, one-half of the stab flank 1405 height plus the predetermined constant, δ, as measured from the thread root 1420). The offset pitch line is not parallel to the root, the crest, or the longitudinal axis of the pipe body (not independently illustrated). In certain embodiments, the predetermined amount, δ, may be in an inclusive range of 1% and 6% of the load flank height. In other embodiments, the predetermined amount, δ, may be in an inclusive range of 1% and 3% of the load flank height. In still other embodiments, the predetermined amount, δ, may be in an inclusive range of 3% and 4% of the load flank height. In still other embodiments, the predetermined amount, δ, may be in an inclusive range of 4% and 5% of the load flank height. In still other embodiments, the predetermined amount, δ, may be in an inclusive range of 5% and 6% of the load flank height. However, in all embodiments, the predetermined amount, δ, is smaller than a height of a tooth 1430 of a thread 1425 as measured from root 1420 to crest 1415.

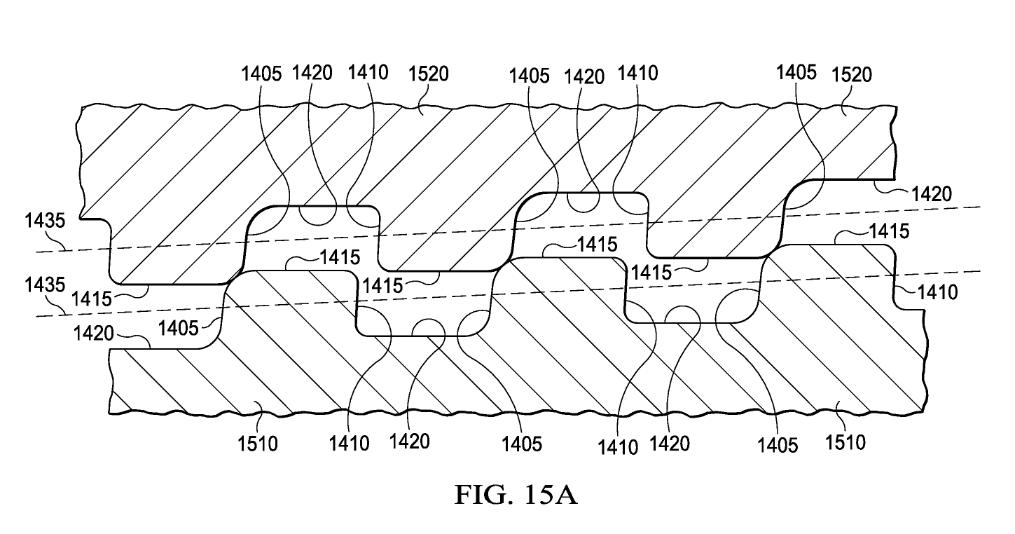

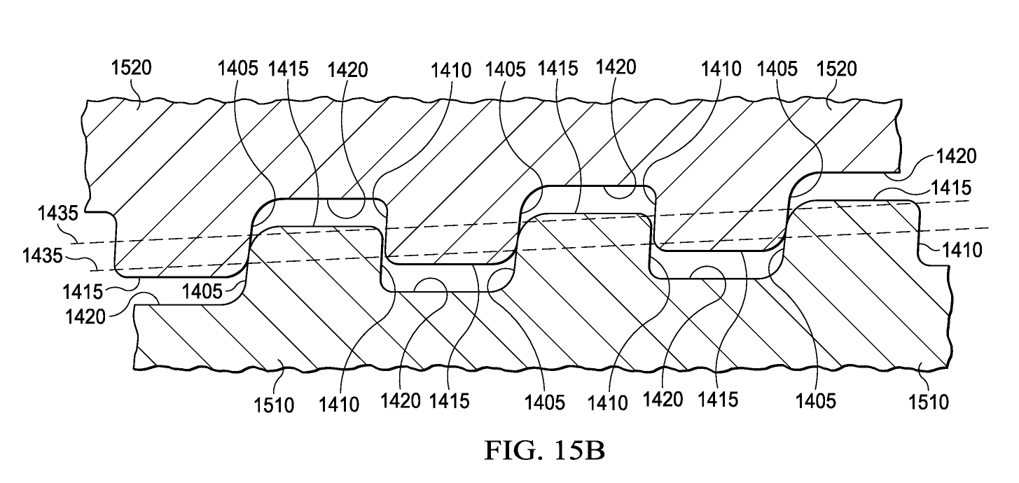

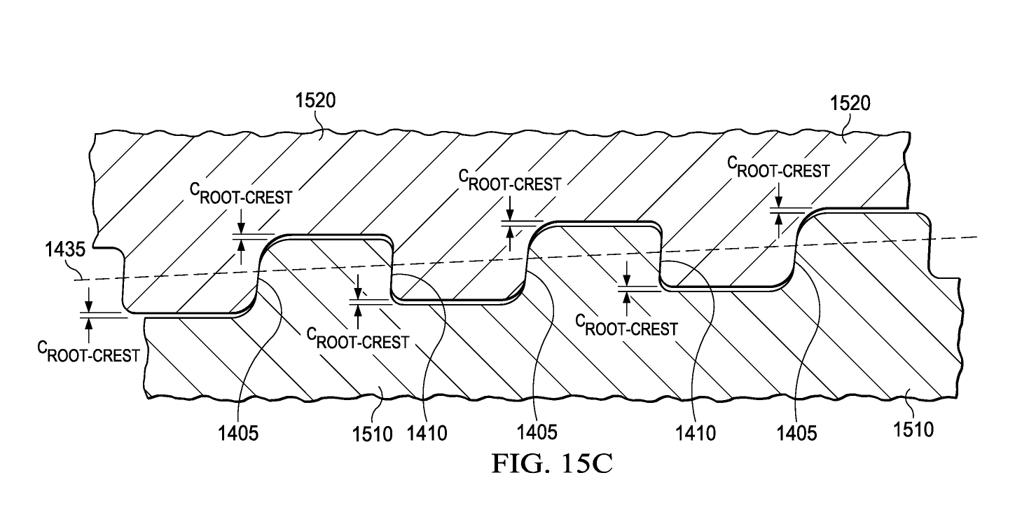

The radii that join the stab flank 1405 with both the root 1420 and the crest 1415 are sufficiently large such that in the stab position, a clearance is created between the respective load flanks 1410, allowing the thread tooth 1430 to easily enter the mating thread groove 1432 (e.g., FIG. 15A). During assembly, as one thread 1425 is rotated into its mating thread 1425 (e.g., FIG. 15B), the threads 1425 run freely until the respective offset pitch lines 1435 align, at which point the respective load 1410 and stab 1405 flanks contact. Other aspects of the complete connection, such as, for example, the metal seal (not shown) and positive torque shoulder (not shown) will halt additional rotational motion.

FIGS. 15A, 15B, and 15C show a near-square modified buttress thread form (1400 of FIG. 14), machined as full threads, mating to achieve flank-to-flank contact with root-crest clearance in accordance with one or more embodiments of the present invention. Specifically, FIG. 15A shows a portion of a pin 1510 that includes a plurality of near-square pin threads (1425 of FIG. 14), where each pin thread (1425 of FIG. 14) includes a stab flank 1405, a crest 1415, a load flank 1410, and a root 1420, where the root 1420 and the crest 1415 are substantially parallel to a longitudinal axis of a pipe body (not independently illustrated). The stab flank angle (θ_{Stab Flank} of FIG. 14) of the stab flank 1405 is larger than a load flank angle (θ_{Load Flank} of FIG. 14) of the load flank 1410. FIG. 15A also shows a portion of a box 1520 that includes a plurality of near-square threads (1425 of FIG. 14), where each thread (1425 of FIG. 14) includes a stab flank 1405, a crest 1415, a load flank 1410, and a root 1420, where the root 1420 and the crest 1415 are substantially parallel to a longitudinal axis of a pipe body (not independently illustrated). The stab flank angle (θ_{Stab Flank} of FIG. 14) of the stab flank 1405 is larger than a load flank angle (θ_{Load Flank} of FIG. 14) of the load flank 1410. As the pin 1510 comes into contact with the box 1520, good stab flank 1405 contact is shown with good load flank 1410 clearance. Specifically, the stab position, the initial contact as the pin 1510 is stabbed or inserted into the box 1520, with minimal contact between the pin 1510 and the box 1520 on the stab flanks 1405.

Continuing, FIG. 15B shows a partially assembled position with the stab flanks 1405 engaged and clearance between the load flanks 1410, enabling free-running assembly. As the pin 1510 is rotated into the box 1520, the threads (1425 of FIG. 14) engage with contact on their stab flanks 1405. In addition, as the pin 1510 engages the box 1520 more fully, the pitch lines 1435 come closer to alignment.

Continuing, FIG. 15C shows a final assembled position where the load flanks 1410 engage, with the stab flanks 1405 still engaged. It is important to note that, depending on the tolerances within the threads (1425 of FIG. 14) and other features within the connection such as, for example, metal seals and positive torque shoulders, the assembly process may differ in accordance with one or more embodiments of the present invention. For example, metal seal engagement may shift thread engagement from stab flank 1405 to load flank 1410 before the point of engagement of both flanks. However, as additional torque is applied, the seals will continue to engage and both flanks will engage, or nearly so such that flank-to-flank clearance will be quite small, in the order of less than 0.001 of an inch. Notwithstanding the above, with both flanks 1405, 1410 in contact, further assembly requires a large increase in assembly torque. However, in embodiments that include a properly designed positive torque shoulder, further assembly is halted.

When the pin 1510 an the box 1520 are fully engaged, in addition to flank-to-flank contact, there is root-crest clearance, C_{Root-Crest}, between the crests (e.g., 1415 labeled in FIGS. 15A and 15B) of the pin 1510 and their corresponding roots (e.g., 1420 labeled in FIGS. 15A and 15B) of the box 1520 and the crests (e.g., 1415 labeled in FIGS. 15A and 15B) of the box 1520 and their corresponding roots (e.g., 1420 labeled in FIGS. 15A and 15B) of the pin 1510. In certain embodiments, the root-crest clearance, C_{Root-Crest}, may be in an inclusive range of 0.001″ and 0.004″. In other embodiments, the root-crest clearance, C_{Root-Crest}, may be in an inclusive range between 0.001″ and 0.002″. In still other embodiments, the root-crest clearance, C_{Root-Crest}, may be in an inclusive range between 0.002″ and 0.003″. In still other embodiments, the root-crest clearance, C_{Root-Crest}, may be in an inclusive range between 0.003″ and 0.004″. However, one of ordinary skill in the art will recognize that the root crest clearance may be smaller than 0.001″ or larger than 0.004″ and may vary based on an application or design in accordance with one or more embodiments of the present invention. Because of the flank-to-flank contact, the root-crest clearance allows for some measure of tolerance in fit.

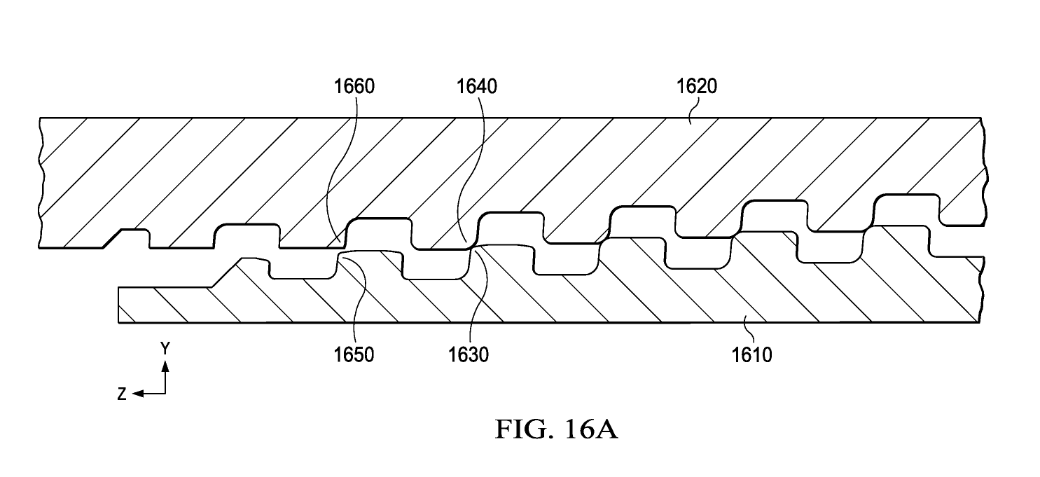

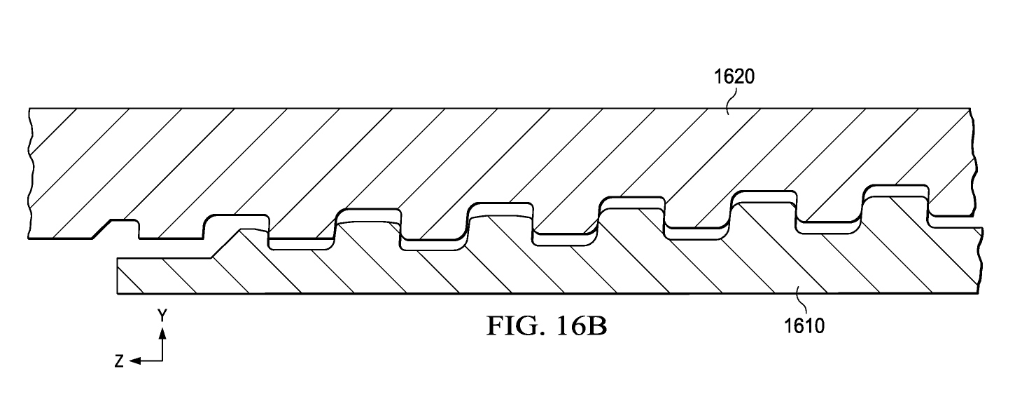

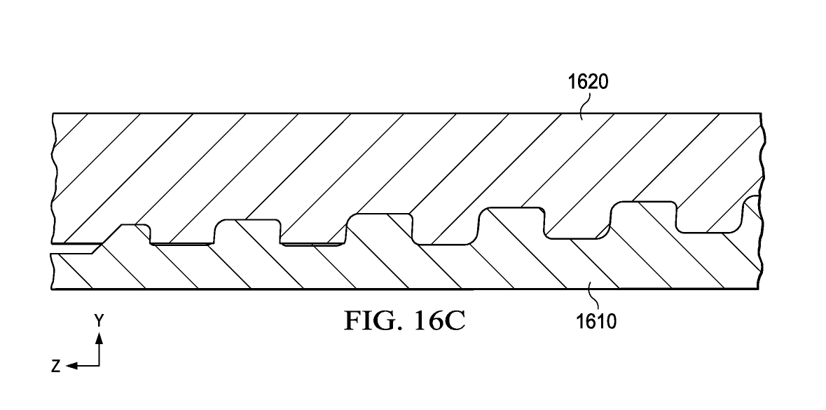

FIGS. 16A, 16B, and 16C show a near-square modified buttress thread form (1400 of FIG. 14), machined as partial threads, mating to achieve flank-to-flank contact with root-crest clearance in accordance with one or more embodiments of the present invention. Specifically, FIG. 16A shows the connection with the run-in threaded pin 1610 stabbed into the run-out threaded box 1620. The threads engage in the fully threaded portion of the thread. The last run-in thread 1630 makes contact on the partial radius of the last run-out thread 1640. On the second run-in 1650/run-out 1660 thread pair, a small clearance exists. Continuing, FIG. 16B shows the run-in (e.g., 1630, 1650 of FIG. 16A) and the run-out (e.g., 1640, 1660 of FIG. 16A) threads partially engaged, approximately 50% engaged. Continuing, FIG. 16C shows the run-in (e.g., 1630, 1650 of FIG. 16A) and the run-out threads (e.g., 1640, 1660 of FIG. 16A) fully engaged. It is important to note that the run-in and the run-out threads mate properly at all stages of assembly.

Advantages of one or more embodiments of the present invention may include one or more of the following:

In one or more embodiments of the present invention, a near-square modified buttress thread form addresses a long felt, but unsolved need in the industry for a thread form that enables flush or semi-flush connections with improved tensile efficiency, and, because the thread form has flank-to-flank engagement, it enables a connection with improved compression resistance, that is easier to manufacture, and is easier to assembly that conventional thread forms.

In one or more embodiments of the present invention, a near-square modified buttress thread form that enables run-in and run-out threads which provides greater connection tensile efficiency and compression resistance. The compression resistance is critical in cyclic loading situations often encountered downhole and represents a substantial improvement over existing flush and semi-flush connections.

In one or more embodiments of the present invention, a near-square modified buttress thread form may provide flank-to-flank contact with root-crest clearance when fully engaged.

In one or more embodiments of the present invention, a near-square modified buttress thread form may provide a near-square thread form that enables partial run-in threads to mate with partial run-out threads.

In one or more embodiments of the present invention, a near-square modified buttress thread form may provide improved flank-to-flank contact that improves resistance to compressive loading and reduces circumferential stress in the fully engaged state.

In one or more embodiments of the present invention, a near-square modified buttress thread form may provide improved tensile strength over other types of connections that lack partial thread engagement.

While the present invention has been described with respect to the above-noted embodiments, those skilled in the art, having the benefit of this disclosure, will recognize that other embodiments may be devised that are within the scope of the invention as disclosed herein. Accordingly, the scope of the invention should be limited only by the appended claims.

What is claimed is:

1. A near-square modified buttress thread form comprising:
a pin comprising a near-square pin thread, wherein the pin thread comprises a stab flank, a crest, a load flank, and a root, the root and the crest are substantially parallel to a longitudinal axis of a pipe body, and a stab flank angle of the stab flank is larger than a load flank angle of the load flank;
a box comprising a near-square box thread, wherein the box thread comprises a stab flank, a crest, a load flank, and a root, the root and the crest are substantially parallel to the longitudinal axis of the pipe body, the stab flank angle larger of the stab flank is larger than the load flank angle of the load flank; and
an offset pitch line that is offset from a midpoint of each flank by a predetermined amount that provides flank-to-flank contact and root-crest clearance when the pin and the box are fully engaged.

2. The near-square modified buttress thread form of claim 1, wherein the offset pitch line intersects the thread form on the load flank at a distance of one-half of the load flank height less the predetermined amount as measured from the crest and intersects the thread form on the stab flank at a distance one-half of the stab flank height minus the predetermined amount as measured from the crest.

3. The near-square modified buttress thread form of claim 1, wherein an included angle between the stab flank and the load flank is positive and is greater than or equal to 1° and less than or equal to 7°.

4. The near-square modified buttress thread form of claim 1, wherein the offset pitch line is not parallel to the root, the crest, or the longitudinal axis of the pipe body.

5. The near-square modified buttress thread form of claim 1, wherein the predetermined amount is smaller than a height of the load flank or the stab flank.

6. The near-square modified buttress thread form of claim 1, wherein the predetermined amount is in an inclusive range of 1% and 6% of the load flank height.

7. The near-square modified buttress thread form of claim 1, wherein the predetermined amount is in an inclusive range of 1% and 3% of the load flank height.

8. The near-square modified buttress thread form of claim 1, wherein the predetermined amount is in an inclusive range of 3% and 4% of the load flank height.

9. The near-square modified buttress thread form of claim 1, wherein the predetermined amount is in an inclusive range of 4% and 5% of the load flank height.

10. The near-square modified buttress thread form of claim 1, wherein the predetermined amount is in an inclusive range of 5% and 6% of the load flank height.

11. The near-square modified buttress thread form of claim 1, wherein the stab flank angle is in a range between 1 degrees and 9 degrees and the load flank angle is in a range between 0 degrees and 7 degrees.

12. The near-square modified buttress thread form of claim 1, wherein the stab flank angle is in a range between 1 degrees and 7 degrees and the load flank angle is in a range between 0 degrees and 4 degrees.

13. The near-square modified buttress thread form of claim 1, wherein the stab flank angle is in a range between 3 degrees and 9 degrees and the load flank angle is in a range between 1 degrees and 7 degrees.

14. The near-square modified buttress thread form of claim 1, wherein flank-to-flank contact comprises contact between the stab flank of the pin and the stab flank of the box and contact between the load flank of the pin and the load flank of the box.

15. The near-square modified buttress thread form of claim 1, wherein root-crest clearance comprises a gap between the root and the crest when the pin and the box are fully engaged.

16. The near-square modified buttress thread form of claim 1, wherein the root-crest clearance is in an inclusive range of 0.001″ and 0.004″.

17. The near-square modified buttress thread form of claim 1, wherein the root-crest clearance is in an inclusive range of 0.001″ and 0.002″.

18. The near-square modified buttress thread form of claim 1, wherein the root-crest clearance is in an inclusive range of 0.002″ and 0.003″.

19. The near-square modified buttress thread form of claim 1, wherein the root-crest clearance is in an inclusive range of 0.003″ and 0.004″.
